(19) United States
(12) Patent Application Publication
(10) Pub. No.: US 2005/0002530 A1
(43) Pub. Date: Jan. 6, 2005

(54) Method and a system for control of unauthorized persons

(76) Inventors: Noam Kogan, Raanana (IL); Edan Almog, Herzliya (IL)

Correspondence Address: BROWDY AND NEIMARK, P.L.L.C.;624 NINTH STREET, NW, SUITE 300, WASHINGTON, DC, 20001-5303, US

(21) Appl. No.: 10/875,959

(22) Filed: Jun. 25, 2004

(30) Foreign Application Priority Data
Jun. 25, 2003 (IL) 156629

(51) Int. Cl. H04N 7/167

(52) U.S. Cl. 380/255

(57) ABSTRACT

A security method and system for the detection and/or control of unauthorized persons among a large number of freely moving authorized persons within a controlled restricted zone, incorporating an infrastructure of control points, electronic means borne by the authorized persons, communication between said electronic means and said control points, and cryptographic protection against forgery, allowing the interception of unauthorized persons by security authorities.

The present invention relates to electronic identification and authentication security methods and systems for the detection and/or control of unauthorized persons among a large number of freely moving authorized persons within a controlled restricted zone, with a high level of forgery proof protection. This field is henceforth referred to as Unauthorized Human Control.

One fundamental aspect of security arrangements for organizations residing in installations, buildings or building complexes of varying sizes, is the prevention and/or control of the presence of unauthorized persons among a large number of authorized persons in restricted zones, particularly where a high level of security is required. Many security threats arise due the existence of unauthorized persons within such restricted zones, for instance exposure of the organizations to criminal, hostile, undesired prying, and more recently, terror activities, enacted upon organizational assets such as documents, materials, equipment, machinery, personnel, etc.

The problem of achieving restricted zones free of the presence of unauthorized persons entrails many difficulties, which are further enhanced by complex restricted zone topologies, intolerance toward single point-of-failure solutions for organizations with high security requirements, and the need to allow a large number of authorized persons to effectively and conveniently operate and move within and throughout the restricted zones. The problem becomes even more difficult for organizations which need to enable the entrance of unaccompanied persons with task-specific authorizations, meaning authorizations which are limited to a predefined duration and/or specific location within the restricted zones, while preventing them from violating their authorization limitations. Typically, visitors, maintenance personnel, workers with various trust degrees such as temporal workers, etc, require such task-specific authorizations.

The traditional means used by security authorities to address the described problem typically consist of physical obstacles such as walls, fences, etc, on the perimeter of the restricted zones and openings in the obstacles, each opening equipped with a checkpoint, requiring every authorized person entering through a checkpoint and/or moving inside the restricted zone, to bear evidence of his/her authorization in the form of a personal permit, which is visually inspected by security personnel manning the checkpoints. This arrangement is sometimes enhanced by security personnel patrolling inside the restricted zone, which inspect permits of suspicious or randomly selected persons. Such a typical permit contains the name, an image, and an ID number of its authorized owner. Security arrangements of this type are vulnerable due to the ease of permit forgery and are largely dependent on manual labor, which may be problematic in terms of cost, dependability, and the ability to contend with a large number of persons entering a single checkpoint simultaneously. Unfortunately, reality shows that these methods do not manage to contain the unauthorized persons within restricted zones at negligible levels, although several different fields of application have been developed in the past in order to improve the solutions for the described problem.

A first example of such a field can be found in automatic access control for humans, in which various methods and systems have been developed in order to introduce some degree of automation to the inspection of whether humans moving through a checkpoint on the perimeter of the restricted zone, are authorized or not. In a typical system of such type, the authorized humans are equipped with a personal permit with a magnetic strip containing identification data and/or an electronic identification device that, providing identification information to a reader, by magnetic means and/or through an electrical connection and/or by electromagnetic means, the reader indicating the result to a security official manning the checkpoint and/or a checkpoint electronic unit controlling a barrier, for instance a turnstile or a door. In some systems, the identification device is additionally made forgery proof by such means as cryptography and smartcard technology. In systems in which the checkpoint is manned, physical barriers, such as turnstiles, gates, narrow passages, etc, are typically incorporated in order to force all entering persons to pass through a small area within the checkpoint in which the authorization is checked for one person at a time, especially when several persons arrive at the checkpoint simultaneously. Such systems are frequently found in entrances to big companies, where there is a need to quickly check the authorization of a large number of workers at the beginning and the end of the working day. In systems in which the checkpoint is unmanned, the physical barrier is typically designed to prevent unauthorized humans from moving through. Examples of such systems are described in U.S. Pat. No. 6,570,487 and U.S. patent application No. 20030107468.

In another typical automatic access control system, each checkpoint is equipped with a device, capable of collecting bio-metric data from each entering person, this data being verified against pre-registered bio-metric data, indicating to a security official manning the checkpoint and/or a checkpoint electronic unit controlling a barrier whether or not the entering person is authorized. Such bio-metric data can be, for instance, a digital fingerprint, a digital imprint of the hand geometry, a digital image of the iris, etc. Such bio-metric data collection devices typically require a specific pattern of behavior on behalf of the inspected persons, and are limited to inspecting one person at a time. Such systems have started replacing manual checkpoints for example in passport control at airports. Examples of such systems are described in U.S. Pat. Nos. 6,041,410 and 6,496,595.

However, all of the proposed solutions in the field of automatic access control for humans have severe limitations in solving the addressed problem for various reasons.

First, the various proposed access control systems are primarily suitable for perimeter oriented solutions due to the obstructive nature of the proposed checkpoints that would otherwise hamper the effective and convenient operation and movement of the large number of authorized persons within and throughout the restricted zone. Manned checkpoints are prone to be obstructive in order to allow the security personnel to verify the authorization of each person moving through them, while unmanned checkpoints are prone to be highly obstructive, due to the need to prevent perpetrators from sneaking behind an unaware authorized person, sneaking in with the cooperation of an authorized person, entering alongside an authorized person in large organizations in which not all authorized personnel know each other, etc. Perimeter focused access control has a high potential damage resulting from a singular security fault, which is unacceptable by organizations with high security requirements, a typical scenario of concern being a perpetrator infiltrating the perimeter and thus having virtually unlimited access to the restricted zone for an unlimited time.

Second, for organizations with complex restricted zone topologies, access control requires a multitude of costly security personnel if the checkpoints are manned, or a multitude of costly unmanned checkpoints designed for a high level of security.

Lastly, preventing persons with task-specific authorizations from violating their authorization limitations requires a human escort, which is costly or impractical.

The field of Unauthorized Human Control has evolved in parallel to Access Control solutions whose limitations have been described above. In essence, Unauthorized Human Control aims at providing the ability to monitor the movement of persons inside the restricted zones, and not only on the perimeter.

In a typical system of such type, wireless communication means are used to monitor the movement of persons inside a restricted zone. The authorized persons, some of which are authorized in only parts of the restricted zone, are equipped with a forgery proof wireless identification device that, when interrogated by a set of transmitters inside the restricted zone, responds with an identification message eventually received by a set of receivers inside the restricted zone. When a person bearing such a device enters a part of the zone for which he is unauthorized, security personnel can be notified. Such a system was proposed for airport security as described in U.S. Pat. No. 6,335,688.

However, this type of solution has severe limitations in solving the addressed problem for various reasons. One problem is that a person who is unauthorized for the entire zone, and therefore has no identification device, but succeeds to enter the restricted zone, is undetected by such a system. Another problem is that a person who is equipped with an identification device may simply destroy or misplace it, in order to evade detection by such a system upon entrance to a part of the restricted zone for which he is unauthorized.

In another typical system of such type, collection devices placed in checkpoints, which are scattered throughout a restricted zone, acquire bio-metric data upon the detection of human presence at the checkpoint, this data being verified against pre-registered bio-metric data regarding authorized persons, in order to identify and determine authorization of the person at the checkpoint. In case of a multitude of persons present simultaneously at a checkpoint, the collection device needs to determine the number of persons present and associate the corresponding bio-metric identification data with each of them. Upon the presence of a person who is not identified or is not authorized at a checkpoint, security personnel are notified. An example of such a system is described in U.S. Pat. No. 5,283,644.

However, this type of solution has severe limitations in solving the addressed problem for various reasons. Such bio-metric data collection devices typically require a specific pattern of behavior on behalf of the inspected persons, and are typically limited to inspecting one person at a time. Although enhancements are developed in order to overcome these limitations, achieving a bio-metric collection device, suitable for such a system which attempts to solve the addressed problem, is liable to be prohibitively expensive and/or difficult to implement. The technological challenge of developing such a device is achieving unobstructive bio-metric one-to-many identification of a multitude of persons simultaneously moving freely through a checkpoint, with low false-alarm and miss-detect rates, at reasonable cost. The overwhelming variety of possible human behaviors at checkpoints renders such a system susceptible to persons eluding successful identification due to random and/or systematic behavioral patterns, thus raising the false-alarm and/or miss-detect rates, and hampering the effectiveness of such a system, especially if perpetrators enjoy the collaboration of some authorized persons.

Several other fields of application, although not tackling the addressed problem, utilize technologies related to the current invention.

One such field of application is alarm systems, in which various methods and systems have been developed in order to alert security authorities upon the entrance of a person into a restricted zone. In a typical system of such type, the restricted zone, whether an apartment, a house or a larger area, is equipped with sensors, for instance infra-red, thermal or a video camera, that are activated by the last authorized person leaving the zone, transmitting an alarm signal to security authorities and possibly also to law enforcement authorities upon sensing a person entering the restricted zone. An authorized person can typically de-activate the sensors for instance by a key, PIN code, etc. Such systems are commonly used in buildings and areas of varying sizes. One such a system is described in U.S. Pat. No. 5,530,429.

However, none of the proposed solutions for alarm systems solve the addressed problem, since they are unable to automatically distinguish unauthorized intruders from the large number of authorized persons effectively and conveniently operating and moving within and throughout the restricted zone.

Another such field of application is exit control, in which various methods and systems have been developed in order to prevent the unauthorized exit of persons confined to a controlled area or the unauthorized removal of objects from a controlled area. In a typical system of such type, transmitters, which are physically attached to the humans or objects in a manner preventing their unauthorized physical displacement, transmit an identification signal at pre-determined times and/or upon electromagnetic wave interrogation, and the controlled area is equipped with antennae capable of receiving these transmissions. If an antenna receives a transmission generated outside the controlled area, and/or none of the antennae receive a transmission from a certain transmitter for a specified duration, security personnel are notified. Examples of such system are described in U.S. Pat. Nos. 5,793,290 and 4,777,477.

However, none of the proposed solutions for exit control solve the addressed problem, since they are unable to detect the presence of unauthorized persons in the controlled area.

Yet another such field of application is human detection and counting, in which various methods and systems have been developed in order to detect and/or count persons as they move past a predefined location. One such typical system includes transmitters transmitting electromagnetic waves towards the persons moving past the predefined location to generate reflected beams from the persons. The reflected beams are received and analyzed in order to detect and count the persons present. Another such typical system includes sensors, which are capable of analyzing a change in the environment of the predefined location caused by the presence of the persons in order to detect and count them. This change can be for instance body weight upon a surface and/or interruption of an electromagnetic beam and/or changes caused by the operation of vital bodily functions, such as body heat, heartbeat, etc. Such systems can be found at entrances to museums, concert halls, etc. Examples of such systems are described in U.S. Pat. Nos. 5,305,390 and 6,504,470.

However, none of the proposed solutions for human detection and counting solve the addressed problem, since they are unable to identify the detected persons.

The present invention solves the addressed problem without any of the weaknesses found in the prior art. It uses a completely different approach, by continuously monitoring the authorization of all the humans moving throughout the restricted zone all the time.

According to the invention, a security method for the detection and/or control of unauthorized humans (10a, 10b, . . . ) among a large number of authorized humans (12a, 12b, . . . ) within a controlled restricted zone (2), is characterized in that all authorized humans are equipped with active permits (60a, 60b, . . . ) planned to perform a cryptographic action involving a secret cryptographic key (64), and the controlled restricted zone is equipped with automatic control points (20a, 20b, . . . ), and optionally with manual control points (40a, 40b, . . . ), each automatic control point detecting all humans entering or moving through a specific section (21) in its vicinity, and each manual control point selecting humans by the action of an operator, the humans detected by the automatic control points and the humans selected by the manual control points being hereafter referred to as designated humans, both types of control points being planned to acquire the results of said cryptographic actions performed by the active permits of said designated humans, a cryptographic authentication algorithm involving a validation key (74) being further performed upon each acquired said result, both types of control points being further planned to associate said acquired results to said designated humans, the designation of the humans, the acquiring of said results, the association of said acquired results to said designated humans and the performing of said cryptographic authentication algorithm upon said acquired results not requiring a substantial change in the motion conditions and/or the behavior of the humans, classifying as unauthorized at least humans which have been designated but whose said results either have not been acquired or have not been cryptographically authenticated, an alert message being transmitted to security authorities for each human which has been classified as unauthorized, allowing in such a way for an immediate intervention and a possible interception of the unauthorized humans, at least some of the control points, hereafter referred to as particular control points, being moreover planned to acquire physical characteristics of said designated humans, allowing their direct recognition, said alert message including in this case said physical characteristics.

In preferred embodiments of the invention, one has recourse to one or several of the following:
In a method according to the invention, at least some of said active permits, hereafter referred to as particular active permits, additionally have distinct identities (62a, 62b, . . . ), each distinct identity belonging to a group of one or more of said particular active permits, and distinct identity determination being further performed for all designated humans bearing said particular active permits, upon each said acquired result.
In a method according to the invention, said controlled restricted zone contains one or more sub-zones, each human further being authorized or unauthorized for each of the sub-zones, each sub-zone being further equipped with automatic control points and optionally with manual control points, a database (180) of authorization data regarding said particular active permit distinct identities being associated with each sub-zone, each determined distinct identity of a human designated by a control point being further checked against said authorization data in the databases associated with the sub-zones containing that control point, said databases being automatically and/or manually modifiable by the security authorities, additionally classifying as unauthorized humans which have been designated but whose said distinct identities are indicated as unauthorized by the authorization data in at least one of the databases associated with the sub-zones containing that control point.
In a method according to the invention, data regarding said designated humans (such as said particular active permit distinct identities, control points location, times of designation of humans, etc) is additionally recorded, this data being searched for inconsistencies with regard to time and/or humans location, the results of this search assisting security authorities in finding potential impersonations of said particular active permits.
In a method according to the invention, said secret cryptographic keys of at least some of said particular active permits are distinct, each distinct key corresponding to a group of one or more said particular active permit distinct identities, this, according to the level of protection required for those said particular active permits, correspondence between said distinct secret cryptographic keys and said distinct identities being additionally required in order to cryptographically authenticate said results, so that a perpetrator in possession of a particular active permit, is prevented from impersonating a particular active permit with a different distinct secret cryptographic key.
In a method according to the invention, said alert messages are prioritized, according to the control point characteristics, such as its location, alert message history, etc, and/or the time of designation of the human, and/or said acquired physical characteristics if available, and/or current operational intelligence if available, improving the effectiveness of the intervention of the security authorities.
In a method according to the invention, at least some of the humans are equipped with a human communication unit (50) containing their active permit, these humans when classified as unauthorized, being selectively notified immediately upon their classification by means (32) of sending a notification in the control points and/or means (56) of notification in the human communication units.
In a method according to the invention, at least some of the humans are equipped with a human communication unit containing their active permit, the secret cryptographic keys of at least some of said active permits being contained within supports, which can be detached from said human communication units.
In a method according to the invention, the secret cryptographic keys of at least some of said active permits are contained within supports, these supports planned to prevent a perpetrator from finding out, through physical penetration and/or deduction, the secret cryptographic keys they contain.
In a method according to the invention, the secret cryptographic keys of at least some of said active permits are contained within supports, all the information produced during said cryptographic action leading to a possible disclosure of said secret cryptographic keys being exclusively contained in said supports.
In a method according to the invention, at least some of said active permits are additionally associated to PINs (Personal Identification Numbers), said PINs supplied to said active permits by authorized humans, said PINs being additionally required by said active permits in order to generate said results of said cryptographic action, and/or being further required in order to cryptographically authenticate said results.
In a method according to the invention, digital elements of a first type are used in performing the cryptographic actions of at least some of said active permits, said digital elements of the first type being additionally required in order to cryptographically authenticate said acquired results, said digital elements of the first type being furthermore different at different times, preventing in this way the authentication of forgery attempts by recording and replaying of said results.
In a method according to the invention, said digital elements of the first type are based on the outputs of time clocks.
In a method according to the invention, said digital elements of the first type are acquired by the control points and transmitted to the human communication units of said designated humans.
In a method according to the invention, said digital elements of the first type are the elements of predefined series associated with distinct identities.
In a method according to the invention, digital elements of a second type are generated by at least some of said active permits, are used in performing the cryptographic actions of these particular active permits, and are required to be different at different times in order to cryptographically authenticate said results of these particular active permits, preventing in this way the authentication of forgery attempts by recording and replaying of said results.
In a method according to the invention, said control points are moreover planned to acquire a credential from the active permit of each said designated human, said validation key being securely extracted from each acquired credential by performing a cryptographic extraction algorithm involving an extraction key.
In a method according to the invention, said validation key is selected from a list of validation keys, according to said determined distinct identity.
In a method according to the invention, the cryptographic process consisting of said cryptographic actions in said active permits and said cryptographic authentications of said acquired results, is of a symmetric type, an asymmetric type, or a combination of both.
In a method according to the invention, at least some of said control points are further planned to associate each said acquired result to a particular designated human.
In a method according to the invention, the memory contents of said active permits can be altered as a consequence of instructions and/or data transmitted from the control points.
In a method according to the invention, said required change in the motion conditions of the humans is in the range of 0.5×V-1.5×V, V being the average velocity of the humans before reaching the specific section (21) in the vicinity of said control points.

The invention also covers a system that implements the above method, which comprises:
human communication units (50a, 50b, . . . ), borne by all authorized humans, comprising means (52) of activating the transmission of an identification message by the human communication unit, an active permit (60) containing a distinct identity (62), and a transmitter (54),
means of issuing (170), and of revoking (178) of active permits (60a, 60b, . . . ),
at least one database (180) containing authorization data regarding humans,
automatic control points (20a, 20b, . . . ), and optionally manual control points (40a, 40b, . . . ), both distributed in the controlled restricted zone (2), each automatic control point comprising means (22) of detection and counting of all humans entering or moving through a specific section (21) in its vicinity, and each manual control point comprising means of selection (42) of humans by the action of an operator, the humans detected by the automatic control points and the humans selected by the manual control points being hereafter referred to as designated humans, both types of control points additionally comprising means (24) of activating requests for identification to the human communication units of the designated humans, means (26) of reception capable of receiving identification messages transmitted by human communication units, hereafter referred to as human communication unit responses (90a, 90b, . . . ), and a controller (28) capable of associating human communication unit responses to designated humans,
means (130) of retrieving prior data from the database (180),
means (140) of classification of designated humans,
at least one security center (160),
additional means (44) in the manual control points of notifying the manual control point operator,
a communication network (100) between at least some of the control points, the database (180), the means of issuing (170) and revoking (178) of active permits, the means of retrieving prior data (130), the means of classification (140) and the security centers,
   and which is characterized in that:
I) The active permit (60) contains in addition a secret cryptographic key (64) associated to the distinct identity (62) of the active permit (60), and is planned to perform a cryptographic confirmation algorithm (66) involving at least the distinct identity (62) and the secret cryptographic key (64),
II) The human communication unit response (90) comprises the result of the cryptographic confirmation algorithm (66),
III) Means (70) of cryptographic authentication are planned to check for each human communication unit response (90) whether or not the secret cryptographic key (64) corresponding to the distinct identity (62) contained in the human communication unit response (90) was the one used in the calculation of this response (90), this action involving a validation key (74) corresponding to the same distinct identity (62), and a cryptographic validation algorithm (76),
IV) For every newly authorized human, the means (170) of issuing allocate a distinct identity (62), initialize a new active permit (60) to bear the allocated distinct identity (62) and a corresponding secret cryptographic key (64), and update the database (180) with information regarding the newly authorized human (12),
V) The means (178) of revoking are planned to automatically (for example time dependent expiration) and/or manually modify elements in the database (180),
VI) The means of retrieving prior data (130) utilize the distinct identity (62) contained in the human communication unit response (90), in order to retrieve from the database (180), authorization data regarding this human,
VII) The means (140) of classification utilize the data produced by the means (22) of detection and counting, and/or the means (26) of reception, and/or the controller (28), and/or the means (70) of authentication, and/or the means (130) of retrieving prior data, to determine whether a designated human is authorized or not,
VIII) Means (150) of alert convey to at least one security center (160) and/or to the means (44) of notifying the manual control point operator, an alert message containing the data provided by the means (26) of reception, and/or the controller (28), and/or the means (70) of authentication, and/or the means (130) of retrieving prior data, for at least some of the humans classified as unauthorized,
IX) At least some of the control points comprise in addition means (30) of acquiring physical characteristics of designated humans, such as photographic information, height, weight, features, etc . . . , the means of alert (150) additionally include said acquired physical characteristics in at least some of the alert messages,

In more preferred embodiments of the invention, one has recourse to one or several of the following:
In a system according to the invention, the means (70) of authentication are additionally planned to determine the validation key (74), by utilizing the distinct identity (62) contained in the human communication unit response (90), to select from a validation key list (80) containing for each distinct identity (62) a corresponding validation key (74), and the means (170) of issuing are also additionally planned to update for every newly authorized human (12) the validation key list (80) with the allocated distinct identity (62) and the corresponding validation key (74).
In a system according to the invention, the human communication unit response (90) additionally comprises a credential (174), the means (70) of authentication being additionally planned to determine the validation key (74), by utilizing a cryptographic extraction algorithm (86) involving an extraction key (78), in order to securely extract the validation key (74) from the credential (174) contained in the human communication unit response (90), and the means (170) of issuing being also additionally planned to initialize for every newly authorized human (12), the active permit (60) with a credential (174) containing the result of a cryptographic binding algorithm (176) involving the validation key (74) and a binding key (172) which corresponds to the extraction key (78).
In a system according to the invention, the means (24) of activating requests for identification transmit to every designated human an interrogation message.
In a system according to the invention, the means (24) of activating requests for identification comprise a trigger element in the vicinity of the control point, that is planned to be detectable by means (52) in the human communication units.
In a system according to the invention, utilized to perform additional functions such as Admittance Fee Collection, Access Control, in particular on the perimeter of the controlled restricted zone and/or any of its sub-zones, Messaging, Crew Management, statistical survey, a crime investigation tool, etc.
In a system according to the invention, the human communication unit (50) is powered by an internal power source (58), and/or by a coil (59) converting the energy of an RF wave generated by means (38) in the control points.

Before describing the invention in detail, it should be noted that the terminology used for describing the invention is intended to be understood by those that are skilled in the art to which the current invention belongs.

The invention will now be described with more detail in a non-limitative way by referring to the figures given here in a purely illustrative way:

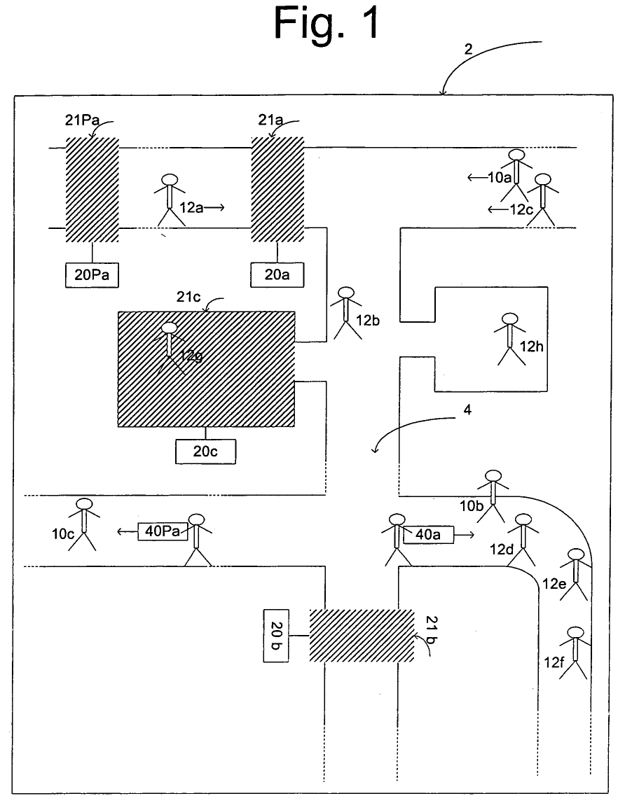

FIG. 1 is a general outline of a controlled restricted zone, in which the method and/or the system according to the invention is implemented for the detection and/or control of unauthorized humans, among a large number of authorized humans;

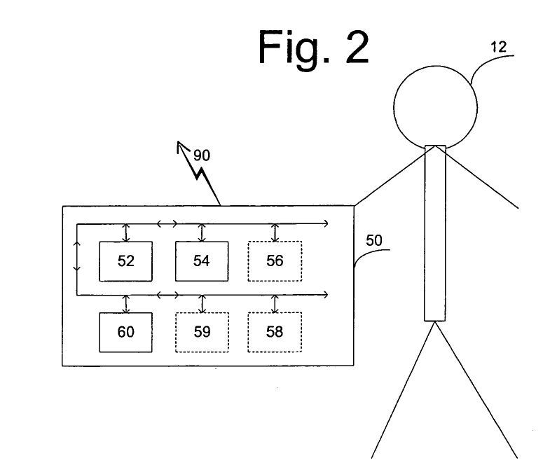

FIG. 2 is an exploded schematic diagram of the human communication unit borne by an authorized human of the present invention;

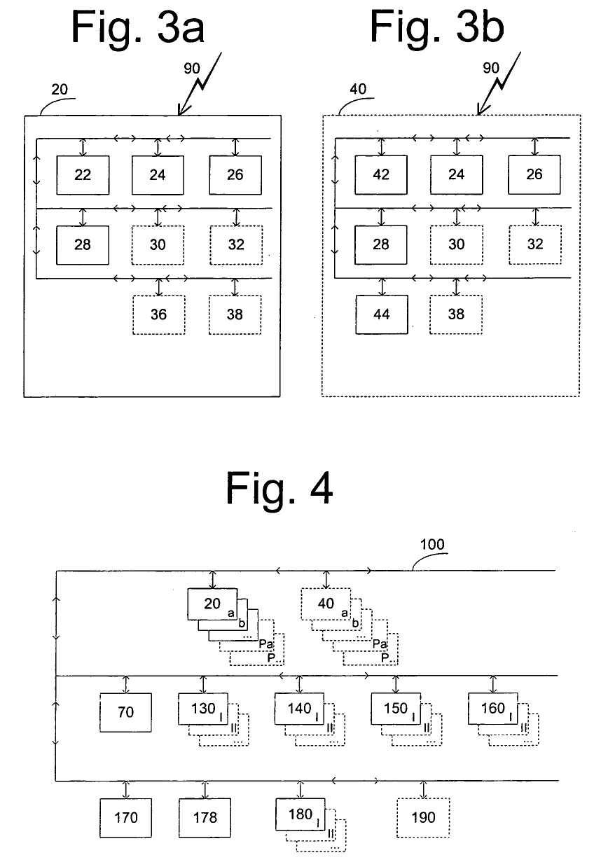

FIG. 3a and 3b are exploded schematic diagrams of the automatic and the manual control points correspondingly of the present invention;

FIG. 4 is an exploded schematic diagram of a the communication network of the present invention;

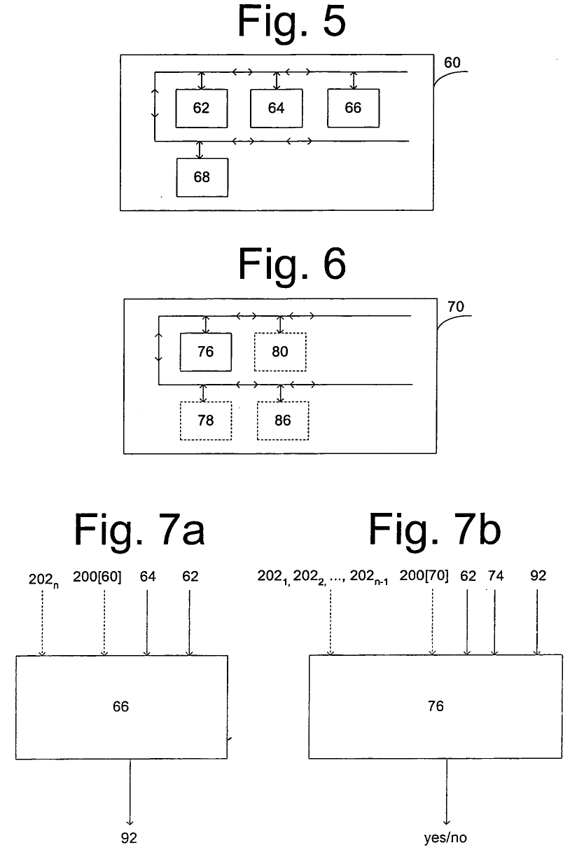

FIG. 5 is an exploded schematic diagram of the active permit of the present invention;

FIG. 6 is an exploded schematic diagram of the means of authentication of the present invention;

FIG. 7a and 7b are schematic diagrams of the inputs and the outputs of the cryptographic confirmation and validation algorithms in the active permit and in the means of authentication of the present invention correspondingly;

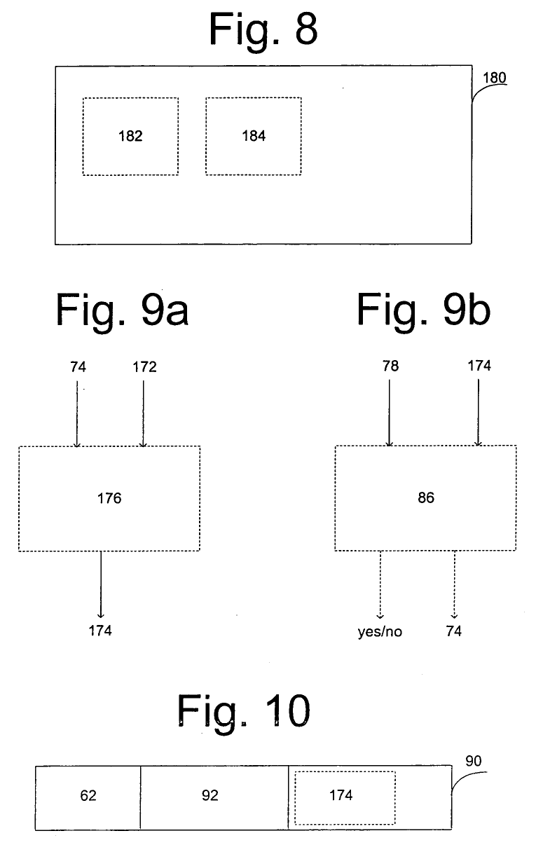

FIG. 8 is an exploded schematic diagram of the database of the present invention;

FIG. 9a and 9b are schematic diagrams of the inputs and the outputs of the cryptographic binding and extraction algorithms in the means of issuing and in the means of authentication of the present invention correspondingly;

FIG. 10 is a schematic diagram of the human communication unit response of the present invention;

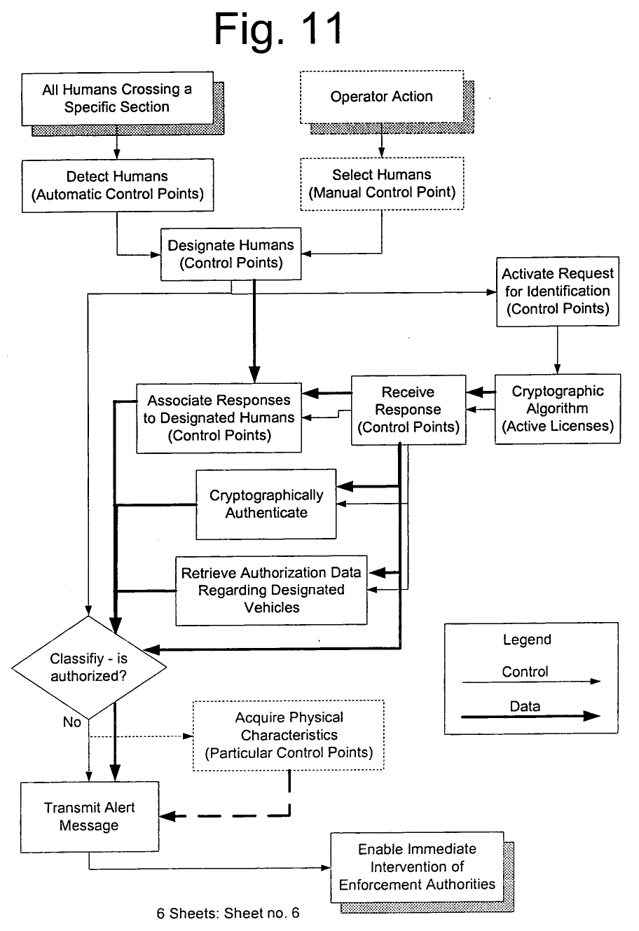

FIG. 11 is an example of a sequence of steps for the detection and/or control of unauthorized humans, among a large number of authorized humans according to the invention;

Authorized humans (12a, 12b, . . . ), and some unauthorized humans (10a, 10b, . . . ) are scattered in a controlled restricted zone (2) comprising a network (4) of spaces and interconnecting passageways, both of which are hereafter referred to as sections, the authorized and unauthorized humans being stationary and/or moving, and all authorized humans being provided with human communication units (50a, 50b, . . . ). The controlled restricted zone can be a part of a building, an installation comprising many buildings or even an entire country or group of countries. Furthermore, the controlled restricted zone can consist of a number of unconnected parts.

Automatic control points (20a, 20b, ..., 20Pa, . . . ) are placed in the vicinity of several specific sections (21a, 21b, . . . ), and security authorities patrols are equipped with manual control points (40a, 40b, . . . , 40Pa, . . . ), these manual control points being either stationary of moving.

Each automatic control point includes components mounted for example on a ceiling and/or on a wall and/or in the floor adjacent to the specific section (21). Each automatic control point comprises means (22) of detection and counting of all humans moving through the specific section (21) in its vicinity, the detected humans hereafter referred to as “designated humans”, each automatic control point additionally comprising means (24) of activating requests for identification to the designated humans, means (26) of reception, capable of receiving human communication unit responses (90) to requests for identification, and a controller (28) capable of associating these human communication unit responses to designated humans, some of the automatic control points comprising moreover means (30) of acquiring physical characteristics of the designated humans, allowing their direct recognition. The means (22,24,26,28,30) are planned to operate without requiring a change in the motion conditions and/or behavior of the humans moving through the specific section (21), in particular not requiring designated humans' awareness.

The means (22) of detection and counting can be made by any known technique in the field of human detection and counting such as a weighing device, a sensor triggered by the interruption of an electromagnetic beam, infrared heartbeat detection, etc.

A first example of implementation of means (24), includes a transmitter in the automatic control point which sends to human communication units of designated humans an electromagnetic wave through a directive antenna, carrying a request for identification message, this wave being typically in the frequency range of 1 Mhz-30 Ghz, preferably between 10 Mhz-2.5 Ghz, the human communication units comprising means (52) of activating the transmission of an identification message, for instance a receiver operating in the same frequencies and a receiver controller analyzing said message.

A second example of implementation of means (24), includes a trigger element in the vicinity of the control points that is detectable by means (52) of the human communication units, said trigger element being for instance a magnet or a loop supplied with a current, generating a magnetic field, means (52) being in this case a sensor comprising an element which responds to magnetic fields by a change of a current or a voltage, for instance a Hall effect detector, an inductive loop, a transformer, etc, and a sensor controller analyzing said change.

An example of implementation of means (30) includes a digital camera. This implementation can produce compressed images of designated humans.

The humans detected by means (22), the humans which received a request for identification from means (24), the humans whose communication units (50) transmitted the responses (90) received by means (26), and the humans whose physical characteristics were acquired by means (30), are each associated with geometric parameters related to the specific section (21), and to the means (22,24,26,30) in the control point.

In an example of implementation, the geometric parameters include the angle and range of a sensor in the means of detection and counting, the coverage area of the antenna that receives the human communication unit response, and the change in the human's position as derived through analysis of an image collected by a digital camera in the means of acquiring physical characteristics. The choice of these geometric parameters can be made by any known technique, for instance as commonly used in human detection and counting systems.

The controller (28) is capable of processing said geometric parameters in order to control the operation of means (24,26,30), and associate the data collected by means (26,30) with humans detected by means (22). In an example of implementation of the controller, the geometric parameters reported by the means (22) of detection and counting regarding a particular detected human, are used by the controller to adjust the angle of a directive antenna of means (24), and the focus distance of a camera in means (30). In the same example, the data collected by means (26,30) is associated with humans detected by means (22) according to the result of a geometric conjunction calculation performed by the controller.

Other examples of associating transmissions received from humans and acquired human physical characteristics with detected humans by processing geometric parameters can be found in the field of human detection and counting systems.

In some cases, it may be beneficial to place the automatic control points so that they are concealed and/or easily and quickly transferable from one section to another.

The human communication unit is a portable self-contained device, which can be borne for example in the form of a tag attached to a garment, held in a pocket, etc.

The human communication unit additionally comprises a transmitter (54), and an active permit (60). The active permit is planned to contain the distinct identity (62), a secret cryptographic key (64), a communication port (68) intended for initialization and maintenance of data kept in the active permit, particularly the secret cryptographic key, and to perform a cryptographic confirmation algorithm involving the secret cryptographic key, for example encrypting a field consisting of the distinct identity and a checksum with the secret cryptographic key.

In a first example of implementation, the human communication unit is powered by an internal power source (58), such as a battery or a rechargeable battery, while in a second example of implementation, it is powered by a coil (59) converting the energy of an RF wave generated by means (38) in the control points.

In a first example of implementation, the active permit is an integrated circuit comprising a processor executing a program residing in memory, the cryptographic confirmation algorithm being for instance part of said program, or implemented in dedicated hardware circuitry, the distinct identity and secret cryptographic key being also stored in memory.

In a second example of implementation, the active permit is a smartcard which has the same capabilities as the above described electronic card, implemented in a single integrated circuit, embedded for instance in a plastic support of a given standard size.

The transmitter (54) sends to the control points an electro-magnetic wave carrying a human communication unit response (90), this response consisting for example of a field containing the distinct identity and a crypto-bits field (92) containing the result of the cryptographic confirmation algorithm, the transmitter being made by any known technique, and the electromagnetic wave being typically in the frequency range of 1 Mhz-30 Ghz, preferably between 10 Mhz-2.5 Ghz. The means (26) of reception in the control points receive the response through for example a directive antenna, operating in the same frequencies as the transmitter (54), and analyze this human communication unit response.

Each manual control point comprises means (42) of selection of humans by an action of an operator, the selected humans also referred to hereafter as “designated humans”, each manual control point additionally comprising means (24) of activating a request for identification to the designated humans, means (26) of reception, capable of receiving human communication unit responses to requests for identification, a controller (28) capable of associating said responses to said designated humans, and means (44) of notifying the manual control point operator (e.g. LCD display, sound) of the classification means result, some of the manual control points comprising moreover means (30) of acquiring physical characteristics of the designated humans. The means (24,26,28,30,42,44) are preferably but not limitatively planned to operate without requiring a substantial change in the motion conditions and/or behavior of the selected humans.

Means (24,26) in the manual control points, are similar to their corresponding means in the automatic control points, particularly operating in the same frequency range since they both interact with the human communication units borne by the humans. Of course, they may use different components than those used in the automatic control points, for instance in order to make the manual control points portable.

The means (42) of selection are for example a button pressed by the manual control point operator, upon for example directing an aiming device at a particular human.

The humans selected by means (42), the humans which received a request for identification from means (24), the humans which transmitted the human communication unit responses received by means (26), and the humans whose physical characteristics were acquired by means (30), are each associated with geometric parameters related to the aiming device position, and to the means (42,24,26,30) in the manual control point.

In an example of implementation, the geometric parameters include the angle of an aiming device comprising the means of selection, the shape of the lobe of the transmitter, and the coverage area of the antenna that receives the human communication unit response.

In an example of implementation, the geometric parameters of means (42,24,26,30) are designed to ensure that, given proper aiming by the operator, sufficient geometric data is acquired to enable the controller (28) to distinguish the response or the lack of response of the communication unit (50) of the selected human from responses possibly received from the communication units (50) of other humans.

Some of the various system components described herein, such as the control points, are distributed throughout the controlled restricted zone, while others, such as the security centers (160), may be located at any location inside or outside the controlled restricted zone. The communication network interconnects the various components, specifically the control points, the database (180), the means of issuing (170) and revoking (178) of active permits, the means (70) of authentication, the means of retrieving prior data (130), the means of classification (140), the means of alert (150) and the security centers.

As for the means (70) of authentication, in an example of implementation, the means (70) of authentication comprise the validation key list containing the validation keys of all the active permits and the distinct identities pointing to them, and are additionally planned, upon receiving a human communication unit response, to utilize the distinct identity extracted from the human communication unit response as an index to the validation key list, pointing to the corresponding validation key, this validation key being then used by the cryptographic validation algorithm to check whether or not the corresponding secret cryptographic key is the one which was used by the cryptographic confirmation algorithm in the generation of the received crypto-bits field, the cryptographic validation algorithm consisting for example of the decryption of the crypto-bits field.

In a first example of layout of the communication network, the means (70) of authentication, the means (130) of retrieving prior data, the means (140) of classification, and the means (150) of alert are incorporated inside the control points, and a global domain (a “Local Area Network” LAN) interconnects all the control points with the means (170) of issuing, the means (178) of revoking, the database (180), and the security centers.

In a second example of layout of the communication network, the means (70, 130, 140 and 150) are not incorporated inside the control points, but are rather part of the described Local Area Network. Any of means (70,130,140,150,160,170,178,180) can be implemented in a distributed manner at different locations connected by the communication network.

Several well-known types of communication channels can be used to implement the LAN. One example is Ethernet communication networks. Another example is Wireless LAN communication networks.

In an example of the initialization process of issuing an active permit to a newly authorized human, the means of issuing (170) allocate a distinct identity unique to the active permit or shared by a group, generate a secret cryptographic key unique to the distinct identity or shared by a group, calculate a corresponding validation key, initialize a new active permit that bears the allocated distinct identity and the secret cryptographic key, update, via the communication network, the means (70) of authentication with the new distinct identity and validation key, equip the newly authorized human's human communication unit with the new active permit, and update the database (180) with information regarding the newly authorized human, such as ID number, digital face image, etc . . . , particularly updating the authorized human list.

A first example of implementation of means of issuing (170), well adapted to the described first example of implementation of the active permit, includes a PC connected by a cable and an adapter to the communication port in the active permit, communicating via a communication protocol, for instance a USB protocol, a serial communication protocol, an Ethernet protocol, etc.

A second example of implementation of means (170), well adapted to the described second example of implementation of the active permit, includes a PC connected to a smartcard reader, in which the active permit (being in this case a smartcard) is inserted, communicating via a smartcard communication protocol, for instance via ISO 7816/1-4 protocols.

The cryptographic process comprising the confirmation and validation algorithms is primarily provided for the purpose of verifying the authenticity of the active permit in the human communication units.

In a first example of implementation of this cryptographic process, the secret and validation cryptographic keys (64,74) are of a symmetric type (“symmetric key cryptography”—SKC for those skilled in the art).

In a second example of implementation, the secret and validation cryptographic keys (64,74) are of an asymmetric type (“Asymmetric key cryptography”, hereafter referred to as AsKC), utilizing “public key cryptography”, “elliptic curve cryptography”, etc.

It can be noted that in some cases it can be advantageous to use a combination of both types (SKC and AsKC).

One advantage of SKC is that it enables a strong cryptographic protection at a given length of the human communication unit response, by allowing a longer key.

One advantage of AsKC is that the validation keys (i.e. the public keys) stored in the means (70) of authentication do not have to be kept secret, which can reduce to some extent the level of physical protection required for the means (70) of authentication.

The number of distinct identities sharing each secret cryptographic key and validation key is determined for example according to the level of security required for the humans bearing those distinct identities, thus balancing the implementation complexity with the security requirements.

It can be additionally advantageous to issue each active permit with multiple secret cryptographic keys, each belonging to a different key set, providing the means (70) of authentication with only a single set of validation keys at a given time, and the control points indicating as part of the request for identification, which of the keys in the active permit to use. When it is desired to switch to the next key set, the entire validation key set in the means (70) of authentication is replaced, and the key selection indications in all the requests for identification are changed correspondingly to select the key belonging to the new set.

In a particular variant of the above described initialization process based on AsKC, the means of issuing (170) require the active permit to generate the secret cryptographic key and calculate the corresponding validation key, the means of issuing (170) further reading the validation key from the active permit, the rest of the above described initialization process unchanged, the described variant being especially advantageous since the secret cryptographic key (i.e. the private key) is generated by the active permit and never leaves the active permit, thereby reducing the exposure of the secret key to a minimum.

Several active permit arrangements may be advantageous in preventing perpetrator attempts to gain access to the secret cryptographic key contained within.

One such arrangement involves placing the memory, which contains the secret cryptographic key on a removable support. This can be advantageous for instance by allowing an authorized human to maintain possession of the secret key without the need to carry the human communication unit, when outside the controlled restricted zone.

Another such arrangement involves placing the memory, which contains the secret cryptographic key on an anti-tamper support preventing a perpetrator from finding out, through physical penetration and/or deduction, the secret cryptographic key.

Still another such arrangement involves placing the memory, which contains the secret cryptographic key and the processor which performs the cryptographic confirmation algorithm, inside a support, in a manner that the secret cryptographic key and all the information produced while performing the cryptographic confirmation algorithm, leading to a possible disclosure of the secret cryptographic key, never leave said support, except for possibly during the initialization process of the active permit, being particularly advantageous when said support is additionally planned in accordance with the characteristics of the support described in any of the above two arrangements.

A technology commonly used for implementing a protective support containing memory and processing capabilities, often used in security related applications, is smartcard technology, in which case the active permit is a tamper-proof smartcard, containing both the secret cryptographic key and the entire implementation of the cryptographic confirmation algorithm, and can additionally be removable.

Other examples of technologies for implementing a protective support containing memory and processing capabilities, are PCMCIA cards, or USB tokens.

Several enhancements to the cryptographic process may be advantageous in preventing perpetrator attempts to impersonate an active permit by recording and replaying a human communication unit response of an active permit of a human communication unit of an authorized human, hereafter referred to as replayed response. This can be achieved by planning the cryptographic algorithms (66,76) of the active permit and the means (70) of authentication, in a way that transmitting a replayed response to a request for identification, in response to another request for identification would result in an authentication failure, typically by planning the results of the cryptographic confirmation algorithm of the active permit of an authorized human to be different at different times.

A first example of a replay prevention technique is by providing both the active permits of authorized humans and the means (70) of authentication with the capability to acquire the same digital element (200) of a first type, which is different at different times, the digital element of the first type acquired by the active permits denoted (200[60]), and the digital element of the first type acquired by the means (70) of authentication denoted (200[70]). The digital element (200[60]) is involved in the cryptographic confirmation algorithm of the active permit, and thus affects the crypto-bits field, the means (70) of authentication being additionally planned to compare digital element (200[60]), extracted from the crypto-bits field, with the digital element (200[70]), a positive comparison result being also additionally required for the successful authentication of the human communication unit response.

An example of involving the digital element (200[60]) of the first type in the cryptographic confirmation algorithm can be by additionally encrypting the digital element (200[60]) with the secret cryptographic key, the extraction of the digital element (200[60]) from the crypto-bits field being accomplished in this case by decrypting the crypto-bits field with the validation key.

A first example of implementation of this technique is creating the digital element (200[60], 200[70]) both in the active permit and in the means (70) of authentication using separate clocks planned to provide a similar time reading.

A second example of implementation of this technique is generating a digital element (200) by any means connected to the communication network (e.g. the control points), transferring it to the means (70) of authentication (digital element (200[70])) through the communication network, and transmitting it to the active permit (digital element (200[60])) of the designated human as a part of the identification request.

A third example of implementation of this technique is to supply all the active permits and the means (70) of authentication with a predefined series. Each active permit additionally contains an index A to this series. As a result of an identification request, the active permit uses the element in the series pointed to by the index A as the digital element (200[60]), and increments the index A. The means (70) of authentication contain a separate index B for each distinct identity, the cryptographic validation algorithm being planned to check whether the digital element (200[60]) extracted from the crypto-bits field, exists in the predefined series, with an index greater than index B corresponding to the distinct identity extracted from the human communication unit response. If such an element exists, it is regarded as digital element (200[70]), and index B is updated to be identical to index A.

A second example of a replay prevention technique is by providing each active permit the capability to generate a digital element of a second type, either randomly and/or deterministically, which is different at different times (202₁, 202₂, . . . ), the digital element (202ₙ) being involved in the cryptographic confirmation algorithm of the active permit, and thus affecting the crypto-bits field. The means (70) of authentication are additionally planned to extract the digital element (202ₙ) from the received crypto-bits field, for example by decrypting the crypto-bits field, accumulate the extracted digital elements associated with each distinct identity, and compare the extracted digital element (202ₙ), with all the previously extracted and accumulated digital elements (202₁, 202₂, . . . , 202ₙ₋₁) associated with the distinct identity extracted from the human communication unit response. If the received digital element is found in the accumulated list, it is regarded as a replay attempt, and therefore the human communication unit response is not authenticated.

In another human communication unit arrangement of particular interest, it may be advantageous to prevent a perpetrator from utilizing a stolen human communication unit, or active permit, to impersonate an authorized human.

In this arrangement, the initialization process of each active permit is enhanced in a way that the means (170) of issuing additionally supply a PIN to the user to which the active permit is issued. The authorized human is requested to enter the PIN to the active permit by a keyboard in the human communication unit, at predefined events, such as upon switching on the human communication unit, the entered PIN being typically stored in volatile memory within the active permit, and erased upon occurrence of a predefined event such as turning off the human communication unit.

In a first example of this arrangement, the entered PIN is additionally involved in the cryptographic confirmation algorithm, for example by additionally encrypting the entered PIN with the secret cryptographic key, the means (170) of issuing additionally supplying in this case the PIN to the means (70) of authentication during the initialization process, and the means (70) of authentication also additionally utilizing the distinct identity as an index to a list pointing to the corresponding PIN, enabling the means (70) of authentication to check through the cryptographic validation algorithm whether or not the same PIN is the one that was used by the cryptographic confirmation algorithm in the generation of the received crypto-bits field.

In a second example of this arrangement, the PIN is additionally supplied to the active permit by the means (170) of issuing during the initialization process, the active permit requiring the PIN supplied by the user to be equal to the PIN supplied during the initialization process, in order to enable the generation of the human communication unit response.

In all cases, the cryptography embedded in the invention severely limits the threat raised by perpetrators, even if they are well equipped.

The above-described implementation of the invention can be modified in a manner eliminating the need to update the means (70) of authentication with each newly authorized human, this modification, described hereafter, being referred to as indirect validation system.

In an indirect validation system, the means (70) of authentication do not contain the validation key list, but are rather planned to securely extract the validation key from a credential (174) received as an additional part of each human communication unit response, utilizing the extraction key (78) and the cryptographic extraction algorithm (86), the extracted validation key being used in a similar manner as in the above-described implementation of the invention.

The active permit is additionally planned to incorporate the credential into the human communication unit response, for example as an appended additional field.

For each newly authorized human, the means (170) of issuing are planned to additionally initialize the new active permit with the credential, which is calculated by utilizing a binding key (172), the validation key of the initialized active permit and a cryptographic binding algorithm (176), as part of the initialization process.

In a first example of implementation of an indirect validation system, the credential comprises an encryption of the validation key performed utilizing the binding key and the cryptographic binding algorithm. In this case, the means (70) of authentication accomplish the secure extraction of the validation key by decrypting the credential, utilizing the extraction key and the cryptographic extraction algorithm.

In a second example of implementation of an indirect validation system, the credential comprises a field containing the validation key and a field containing the result of the cryptographic binding algorithm on the validation key, utilizing the binding key, in which case the means (70) of authentication additionally verify that the binding key was the one used in the generation of the credential, by utilizing the extraction key and the cryptographic extraction algorithm, this verification being additionally required in order to successfully authenticate the human communication unit response.

In a first example of implementation of the credential and the secure extraction of the validation key from it, the cryptographic keys (78, 172) are of a symmetric type, while in a second example, the cryptographic keys (78, 172) are of an asymmetric type.

Several examples of implementation of the process of revoking active permits of authorized humans will be now described in a non-limitative way.

A first example of active permit revocation, is when an active permit, is valid for a predetermined limited period of time, this period expiring without action being taken to renew the validity of the active permit. In such a case the means (178) of revoking automatically update the database (180) to indicate that the human whose authorization has expired is unauthorized.

A second example of active permit revocation is when a security authority initiates the revocation of a human's authorization, as a result either of information regarding suspicious activity of that human. In such a case the means (178) of revoking update the database (180) to indicate that the human is unauthorized according to the security authorities initiated revocation.

In both above examples, the implementation of active permit revocation can be made by deleting the human communication unit active permit's distinct identity from the authorized human list and/or adding the human communication unit active permit's distinct identity to the unauthorized human list.

It can be noted, that the means (178) of revoking could also provide a possibility for restoring the status of an authorized human to formerly revoked humans.

As for the database (180), in a first example of implementation, the database (180) comprises a list of distinct identities of active permits in authorized humans' communication units (50), hereafter referred to as authorized human list, indicating as unauthorized humans that do not appear in the authorized human list.

As for the database (180), in a second example of implementation, the database (180) comprises a list of distinct identities of active permits in unauthorized humans' communication units (50), hereafter referred to as unauthorized human list, indicating as unauthorized humans that appear in the unauthorized human list.

As for the database (180), in a third example of implementation, the database (180) comprises a list of distinct identities of all the active permits, and for each distinct identity a corresponding formula for calculating the authorization as a function of time, additionally indicating as unauthorized humans whose said formula currently results in a negative authorization value.

Numerous well known technologies can be used in order to implement the invention. An example of implementation of the communication channel carrying the human communication unit response will now be described in a non-limitative way, taking into account the possible movement characteristics of the humans and the geometry of the control points.

For instance, the human communication unit response can be comprised of the following fields: a bit and frame synchronization field SYNC of a nominal size of [32] bits, typically in the range of [16-64] bits, a distinct identity field of nominal size [32] bits, typically in the range of [16-48] bits, a crypto-bits field of nominal size [128] bits, typically in the range of [64-256] bits, which could be for example the output of any known block cipher, for example 3DES, encrypting a buffer comprised of the concatenation of the time of day TOD and the distinct identity, an error correction field ECC on both the distinct identity and crypto-bits fields, with a nominal rate ⅓, typically in the range of [¼-¾], all this amounting to a nominal total message size of [512] bits, typically in the range of [256-1024] bits. Taking into account the need for an anti-collisions protocol which serves as a MAC layer, such as CD/CSMA or ALOHA protocols, typically combining multiple channels and/or sensing the channel and/or randomness, may double this figure to a nominal effective message size of [1024] bits, typically in the range of [512-2048] bits.

In such a typical implementation, the nominal RF carrier frequency could be around [50 MHz], although there is a wide range of adequate carrier frequencies suitable for this purpose [1 MHz-30 GHz], the nominal frequency band allocated to a channel would be [100 KHz], typically in the range of [10 KHz-1 MHz], the nominal spectral efficiency of [½ Bit/(Hz*sec)], typically in the range of [¼-8 Bit/Hz], all this amounting to a nominal transmission time of the human communication unit response of [1024/(100 khz*½ bit/(hz*sec)=20 msec], typically in the range of [1-200 msec].

In such a typical implementation, the means (24) of activating a request for identification is a trigger element that is sensed by the human communication unit, within a [½ m] bounded geometric region within the specific section (21). Upon sensing the trigger element by means (52), the human communication unit requests the active permit to prepare the human communication unit response, which nominally takes [2 msec], typically in the range of [1 μs-50 ms], comprised mostly of the 3DES calculation.

In such a typical implementation, the means (70) of authentication are implemented in the control point, as described above. Upon receiving the human communication unit response, the means (70) inside the control point verify the crypto-bits field, nominally taking [2 msec], typically in the range of [1 μs-50 ms], the means (130) of retrieving prior data also residing inside the control point, operate in parallel to means (70), also nominally taking [2 msec], typically in the range of [1 μs-50 ms], the means (140) of classification also residing inside the control point, nominally taking [1 msec], typically in the range of [1 μs-50 ms], to decide whether this designated human is authorized or not. Upon a decision that a designated human is unauthorized, the means (140) of classification request the controller (28) to operate means (30) in order to acquire physical characteristics of this human, nominally requiring [25 msec] (e.g. a photo or a video camera), typically in the range of [10-100 msec].

Even for a perpetrator running at a speed of [24 km/hour] ([6.66 m/s]), summing up the time periods described above results in a duration of [20+2+1+25˜50 msec], which corresponds to [33 cm]. Adding the [0.5 m] required by means (24) results in a [0.83 m] human advancement distance from activating a request for identification to acquiring the physical characteristics of an unauthorized human. Assuming that human detection and counting is carried out parallel to activating the request of human identification, this distance is the upper limit to the advancement of a human during the entire interaction between the automatic control point and a designated human.

In such a typical implementation, means (24) are planned at a distance of [2 m] from the antenna of means (26), typically at a distance of [0.5-10 m]. In such a case, the transmission power of the human should allow for reliable RF communications for a nominal distance of [5 m], typically in the range of [1-20 m], in which case a nominal RF transmission power of [30 mwat] can be used—as in other known short range wireless communication systems, although RF transmission power in the range of [1 mwat-1 wat] can also be suitable.

In many cases, it may be advantageous for the automatic control points to be capable of performing an automatic interrogation process, upon all humans moving through the specific section. Multiple humans may be positioned anywhere within the controlled section, at any given time. The control point, according to the invention, needs to associate each of a number of responses simultaneously received by means (26) and each of a number of physical characteristics simultaneously acquired by means (30) with any of a number of humans simultaneously detected and counted by means (22). Means (22, 24, 26, 30) are planned to perform geometrically discernable interaction with a number of humans simultaneously, the controller (28) handling the interaction between the different means. An example of a system with the capability to associate human responses and acquire physical characteristics to detected and counted humans, can be implemented for example by utilizing any known technique of human detection and counting in order to obtain a number of humans present at the specific section at a certain point in time, and comparing that number with the number of authenticated human communication unit responses received at the same time, generating a command to acquire a digital image by a camera aimed at the specific section if not all detected and counted humans were authenticated.

### EXAMPLE OF AN AUTHORIZED HUMAN MOVING THROUGH AN AUTOMATIC CONTROL POINT

An example of implementation of the process, which occurs upon the passage of an authorized human through the specific section monitored by an automatic control point, shall now be described in a non limitative way, this particular process being hereafter referred to as automatic interrogation.

When a human enters the specific section, means (22) detect its presence and report it to the controller (28), the latter requiring means (24) to activate a request for identification to the designated human.

Consequently, means (52) in the communication unit (50) of the authorized human request the active permit to perform the cryptographic confirmation algorithm (66), utilizing the secret cryptographic key, the constructed human communication unit response consisting of a field containing the distinct identity and the crypto-bits field, means (54) consequently transmitting the response to means (26) in the automatic control point.

In one particular variant, the active permit performs said cryptographic confirmation algorithm regardless of any request for identification by the control points, the request for identification in this case causing the result of the cryptographic confirmation algorithm already stored in the active permit memory, to be included in the human communication unit response.

The distinct identity of the active permit is determined from the distinct identity field in the human communication unit response, and is then sent by the means (26) of reception to the controller (28), to the means (70) of authentication, to the means of retrieving prior data (130), and to the means of classification (140), the crypto-bits field being additionally sent to the means of authentication (70).

The controller (28) associates the received human communication unit response with the designated human, and sends the result to the means of classification (140).

In an example of the process of cryptographically authenticating the human communication unit response, upon receiving said crypto-bits field and the distinct identity field, the means (70) of authentication utilize the distinct identity as an index to the validation key list, pointing to the corresponding validation key, this validation key being then used by the cryptographic validation algorithm to decrypt the crypto-bits field, and check whether or not the corresponding secret cryptographic key is the one which was used by the cryptographic confirmation algorithm in the generation of the received crypto-bits field.

The result of the above authentication process is sent to the means (140) of classification.

In a particular variant of the described authentication process, in which SKC is used, the cryptographic validation algorithm is a duplicate of the cryptographic confirmation algorithm, creating a crypto-bits field utilizing the distinct identity and validation key, the created crypto-bits field being compared to the received crypto-bits field, and checking whether or not the resulting fields are matching.

The means (130) of retrieving prior data utilize the distinct identity to retrieve from the database (180) authorization data regarding the human bearing this distinct identity, particularly, to check whether or not the active permit of the designated human was revoked, sending the result to the means (140) of classification.

The means of classification (140) utilize the data produced by the means (22) of detection and counting and/or the means of reception (26) and/or the controller (28), and/or the means of authentication (70) and/or the means of retrieving prior data (130) to determine whether the designated human is authorized or not.

Since in the above example the designated human is authorized, the controller (28) successfully associates the response to the designated human, the means (70) of authentication successfully authenticate the human communication unit response, the authorization data retrieved regarding the designated human do not indicate that it is unauthorized, all of which being required to classify the human as authorized.

### EXAMPLES OF UNAUTHORIZED HUMANS MOVING THROUGH AN AUTOMATIC CONTROL POINT

Some of the advantages of the invention will now be clearly visible, by considering, in a non-limitative way, three examples of unauthorized humans moving through specific sections monitored by automatic control points.

### Example 1

A human which has never undergone the authorization process and thus is not equipped with a human communication unit, for example if having infiltrated the access control at the perimeter of the controlled restricted zone, does not respond to the request for identification message, and thus the controller (28) fails to associate any human communication unit response with the designated human, and the means (140) of classification consequently classify the human as unauthorized.

### Example 2

A human bearing a human communication unit with an active permit that is reported as stolen, and thus appears in the database (180) as unauthorized as a result of the security authorities action through the means (178) of revoking, is indicated as unauthorized by the means (130) of retrieving prior data to the means (140) of classification, and the means (140) of classification consequently classify the human as unauthorized.

### Example 3

A human bearing a human communication unit that has been imitated by a perpetrator, but not the active permit, because of its cryptographic protection, as described above, is indicated as unauthorized due to the means (70) of authentication failing to authenticate the human communication unit response, and thus the means (140) of classification consequently classify the human as unauthorized.

In any of the cases in which the designated human is classified as unauthorized, the means (140) of classification activate the means (150) of alert, which transmit an alert message regarding the unauthorized human, to a security center, the alert message containing the control point identity, the human designation time and any part of the information collected regarding the human which may be advantageous to the interception of the unauthorized human by the security authorities. In the particular automatic control points (20Pa, 20Pb, . . . ), additional information acquired by means (30), such as photographic information, is included in the alert message.

It can be noted that the operation of means (30) of acquiring physical characteristics can be unaffected by the classification result (i.e. means (30) operate for every designated human). In this case, the conditioning of the alert message on the classification result, as well as the inclusion of said acquired physical characteristics in said alert message remain the same as in automatic interrogation. The physical characteristics data regarding humans classified as authorized, may either be accumulated or discarded.

It can be noted that it may be advantageous to additionally prioritize the alert messages according to the control point characteristics, such as its location, alert message history (e.g. RF problems in the vicinity), etc . . . , and/or the time of designation of the human (e.g. at night vs. daytime), and/or the said acquired physical characteristics if available, and/or current operational intelligence if available (e.g. concrete information regarding criminal activity in the area), in order to improve the effectiveness of the intervention of the security authorities.

It can be noted that means (32) of sending a notification in the control points can selectively transmit to humans classified as unauthorized a message, this message being consequently received and brought to the attention of that human by means (56) of notification in the human communication unit (e.g. LED, sound, etc.). In such a way, the active assistance (e.g. contacting security) of law-abiding humans, can help in diminishing the false-alarm rate of the system, and/or improve the capability to prioritize the handling of humans classified as unauthorized.

The invention not only allows for pinpointing the location of any unauthorized human amongst the multitude of authorized humans unobstructively moving through any one of the automatic control points, but also provides the security authorities with the capability to promptly intercept any of the unauthorized humans, by providing sufficient real-time information in order to locate these humans.

### EXAMPLE OF AN AUTHORIZED HUMAN SELECTED BY A MANUAL CONTROL POINT

An example of implementation of the process, which occurs as a result of the selection of an authorized human by a security authority official operating a manual control point, shall now be described in a non limitative way, this particular process hereafter referred to as manual interrogation.

When a security authority official (the operator) decides to examine the status of a particular human, moving or stationary, he performs the selection of this human utilizing means (42), in compliance with the mobile control point's human selection geometric envelope (range, angle, etc). Means (42) consequently report the human designation to the controller (28), the latter requesting means (24) to activate a request for identification to the designated human, similar to that activated by automatic control points to designated humans. The consequent behavior of the human communication unit, therefore, is identical to that of a human communication unit triggered by an automatic control point, generating the transmission of a human communication unit response consequently received by means (26) in the manual control point. The distinct identity and crypto-bits fields extracted from the human communication unit response are dispatched to the relevant means in a similar manner to that of the automatic control point.

The controller (28) determines whether or not a human communication unit response is received from the designated human, and sends the result to the means (140) of classification.

The means (70) of authentication, the means (130) of retrieving prior data, and the means (140) of classification operate in the same manner as described for the automatic interrogation process.

It can be noted that the three previously described examples of unauthorized humans moving through specific sections controlled by automatic control points, can be directly applied to the case of manual control points, leading to the same classification results.

When the designated human is classified as unauthorized, the means (140) of classification activate the means (150) of alert, which transmit an alert message to the operator by means (44), providing him with on-the-spot indication of whether the designated human is authorized or not, and possibly with additional information regarding this human, such as reason for classifying the human as unauthorized, reason of revocation if applicable, etc.

Here also, a strong advantage of the invention results in that the manual control points provide security authorities with an important complementary capability to selectively interrogate moving or stationary humans at any location in the controlled restricted zone, regardless of the automatic control points' dispersement throughout the controlled restricted zone, enabling a security authority official to receive on-the-spot authorization status regarding any chosen human, specifically any unauthorized human, and respond immediately.

The invention is in no wise limited to the modes of embodiment which have been described here-above. Particularly, any component of the invention described herein can be implemented as software instructions executed on a processor, or as a hardware component, or any combination thereof. Any part of the invention described herein as a single element may be implemented as a combination of several elements. Adversely, any group of elements of the invention described herein may be implemented as a single element. The invention is intended to cover all variant, and particularly those in which:

i) The database is additionally planned to record data regarding designated humans, such as distinct identities, control points characteristics (such as their location), times of designation of humans, etc, this data being collected by the control points as the result of the interrogation processes, and being further sent through the communication network to the database (180), this recorded data being processed by an algorithm, which searches for inconsistencies with regard to time and/or humans location.

This variant is advantageous in assisting security authorities in finding potential impersonations of active permits. For example, a distinct identity, which was recorded as the result of two separate interrogation processes, at two control points that are 500 meter apart, within a 10 second interval, indicates a potentially duplicated active permit.

ii) The controlled restricted zone contains multiple restricted sub-zones, each human being further authorized or unauthorized for each of the restricted sub-zones separately and independently, each sub-zone being further equipped with automatic control points and optionally with manual control points, each control point belonging to one of more sub-zones, this enhancement hereafter referred to as multi-zone Unauthorized Human Control system.

In order to achieve this, for each sub-zone, a separate database (180I, 180II, etc) of authorization data regarding said particular active permit distinct identities, and separate means of retrieving prior data (130I, 130II, etc) are implemented. For each sub-zone, the corresponding means of retrieving prior data (130I, 130II, etc) are capable of retrieving human authorization data from the corresponding database (180I, 180II, etc).

The interrogation process of each control point is enhanced in the following manner: the distinct identity field in the human communication unit response is additionally sent by means (26) to the means of retrieving prior data (130) corresponding to each of the sub-zones to which this control point belongs, each of the means (130) of retrieving prior data also additionally utilizing this distinct identity to retrieve from the corresponding database (180) authorization data regarding the human bearing this distinct identity, sending the result to the means (140) of classification.

The means (140) of classification additionally utilize the data produced by the means (130) of retrieving prior data of all the sub-zones to which the control point that designated this human belongs, to determine whether the designated human is authorized or not. A scenario of interest is a human which is being designated by a control point, and whose distinct identity is indicated as authorized by the authorization data in the databases associated with some of the sub-zones containing that control point, but unauthorized in the databases associated with some other sub-zones containing that control point. In one example of implementation the database corresponding to each sub-zone contains authorization data regarding a security clearance specific to that sub-zone. In this example, it is preferably sufficient that one of the databases associated with all the sub-zones which contain that control point indicates the distinct identity of the designated human as unauthorized is order to classify him as such. In another example of implementation the database corresponding to each sub-zone contains authorization data regarding personnel whose tasks require access to that sub-zone. In this example, it is preferably sufficient that one of the databases associated with all the sub-zones which contain that control point indicates the distinct identity of the designated human as authorized is order to classify him as such.

In an example of the multi-zone Unauthorized Human Control system it may be advantageous to have separate means (140) of classification, separate means (150) of alert and a separate security center for any group of sub-zones. In such a case, the means (70) of authentication send their result to all the means (140) of classification of all sub-zones to which the control point which designated this human belongs, each of the means (140) of classification determining whether the designated human is authorized or not separately and independently. In any of the cases in which the designated human is classified as unauthorized by one of the means (140I, 140II, . . . ) of classification, that means (140) of classification activate the corresponding means (150) of alert, which transmit an alert message to the corresponding security center, regarding this unauthorized human.

The controller (28) and means (26) of reception of each automatic control point are configured upon installation with a list of all sub-zones to which it belongs, determining to which means (140) of classification the relevant data is to be dispatched. The sub-zone configuration of each manual control point can either be pre-configured and fixed, or configurable by the operator.

iii) The controlled restricted zone is an entire country and/or a group of countries, and all the authorized citizens and visitors are equipped with the active permits. The control points can be mounted at entrances to public buildings such as libraries, museums, and/or movie theatres, and/or busses. In this embodiment, a strong advantage of the system becomes clear, since the automatic and/or manual control points provide security authorities with an important capability to check the authorization of moving or stationary persons at any location in the entire country and/or group of countries, according to the automatic control point infrastructure and the manual control point dispersement.

As already described in great detail, the invention solves the problem of Unauthorized Human Control. It can be noted, that once such a method and/or system have been implemented, they can be simultaneously used to perform standard applications, however with improved characteristics, and among them:

i) Admittance Fee Collection. For this purpose, the capability of acquiring either the distinct identity for every human that passes through an automatic control point, is utilized by a means (190) of debiting connected to the automatic control point through the data network.

ii) Access Control, in particular on the perimeter of the controlled restricted zone and/or any of its sub-zones. For this purpose, a variation of the automatic control points is planned which additionally incorporates a physical barrier (36), the opening of this barrier being controlled according to the classification result.

iii) Messaging. For this purpose the means (32) of sending a notification and the means (56) of notification are additionally planned to provide the human with information provided by any additional means connected to the data network.

iv) Crew Management and/or a statistical survey tool, and/or a crime investigation tool. For this purpose the data regarding the presence and time of presence of authorized humans in specific control points is transferred at real-time and/or offline through the data network to a means planned to perform fleet management and/or a statistical survey tool, and/or a crime investigation tool.

1. A security method for the detection and/or control of unauthorized humans (10a, 10b, . . . ) among a large number of authorized humans (12a, 12b, . . . ) within a controlled restricted zone (2), characterized in that all authorized humans are equipped with active permits (60a, 60b, . . . ) planned to perform a cryptographic action involving a secret cryptographic key (64), and the controlled restricted zone is equipped with automatic control points (20a, 20b, . . . ), and optionally with manual control points (40a, 40b, . . . ), each automatic control point detecting all humans entering or moving through a specific section (21) in its vicinity, and each manual control point selecting humans by the action of an operator, the humans detected by the automatic control points and the humans selected by the manual control points being hereafter referred to as designated humans, both types of control points being planned to acquire the results of said cryptographic actions performed by the active permits of said designated humans, a cryptographic authentication algorithm involving a validation key (74) being further performed upon each acquired said result, both types of control points being further planned to associate said acquired results to said designated humans, the designation of the humans, the acquiring of said results, the association of said acquired results to said designated humans and the performing of said cryptographic authentication algorithm upon said acquired results not requiring a substantial change in the motion conditions and/or the behavior of the humans, classifying as unauthorized at least humans which have been designated but whose said results either have not been acquired or have not been cryptographically authenticated, an alert message being transmitted to security authorities for each human which has been classified as unauthorized, allowing in such a way for an immediate intervention and a possible interception of the unauthorized humans, at least some of the control points, hereafter referred to as particular control points, being moreover planned to acquire physical characteristics of said designated humans, allowing their direct recognition, said alert message including in this case said physical characteristics.

2. A method as described in claim 1, in which at least some of said active permits, hereafter referred to as particular active permits, additionally have distinct identities (62a, 62b, . . . ), each distinct identity belonging to a group of one or more of said particular active permits, and distinct identity determination being further performed for all designated humans bearing said particular active permits, upon each said acquired result.

3. A method as described in claim 2, in which said controlled restricted zone contains one or more sub-zones, each human further being authorized or unauthorized for each of the sub-zones, each sub-zone being further equipped with automatic control points and optionally with manual control points, a database (180) of authorization data regarding said particular active permit distinct identities being associated with each sub-zone, each determined distinct identity of a human designated by a control point being further checked against said authorization data in the databases associated with the sub-zones containing that control point, said databases being automatically and/or manually modifiable by the security authorities, additionally classifying as unauthorized humans which have been designated but whose said distinct identities are indicated as unauthorized by the authorization data in at least one of the databases associated with the sub-zones containing that control point.

4. A method as described in claim 2, in which data regarding said designated humans (such as said particular active permit distinct identities, control points location, times of designation of humans, etc) is additionally recorded, this data being searched for inconsistencies with regard to time and/or humans location, the results of this search assisting security authorities in finding potential impersonations of said particular active permits.

5. A method as described in claim 2, in which said secret cryptographic keys of at least some of said particular active permits are distinct, each distinct key corresponding to a group of one or more said particular active permit distinct identities, this, according to the level of protection required for those said particular active permits, correspondence between said distinct secret cryptographic keys and said distinct identities being additionally required in order to cryptographically authenticate said results, so that a perpetrator in possession of a particular active permit, is prevented from impersonating a particular active permit with a different distinct secret cryptographic key.

6. A method as described in claim 1, in which said alert messages are prioritized, according to the control point characteristics, such as its location, alert message history, etc, and/or the time of designation of the human, and/or said acquired physical characteristics if available, and/or current operational intelligence if available, improving the effectiveness of the intervention of the security authorities.

7. A method as described in claim 1, in which at least some of the humans are equipped with a human communication unit (50) containing their active permit, these humans when classified as unauthorized, being selectively notified immediately upon their classification by means (32) of sending a notification in the control points and/or means (56) of notification in the human communication units.

8. A method as described in claim 1, in which at least some of the humans are equipped with a human communication unit containing their active permit, the secret cryptographic keys of at least some of said active permits being contained within supports, which can be detached from said human communication units.

9. A method as described in claim 1, in which the secret cryptographic keys of at least some of said active permits are contained within supports, these supports planned to prevent a perpetrator from finding out, through physical penetration and/or deduction, the secret cryptographic keys they contain.

10. A method as described in claim 1, in which the secret cryptographic keys of at least some of said active permits are contained within supports, all the information produced during said cryptographic action leading to a possible disclosure of said secret cryptographic keys being exclusively contained in said supports.

11. A method as described in claim 1, in which at least some of said active permits are additionally associated to PINs (Personal Identification Numbers), said PINs supplied to said active permits by authorized humans, 'said PINs being additionally required by said active permits in order to generate said results of said cryptographic action, and/or being further required in order to cryptographically authenticate said results.

12. A method as described in claim 1, in which digital elements of a first type are used in performing the cryptographic actions of at least some of said active permits, said digital elements of the first type being additionally required in order to cryptographically authenticate said acquired results, said digital elements of the first type being furthermore different at different times, preventing in this way the authentication of forgery attempts by recording and replaying of said results.

13. A method as described in claim 12, in which said digital elements of the first type are based on the outputs of time clocks.

14. A method as described in claim 12, in which said digital elements of the first type are acquired by the control points and transmitted to the human communication units of said designated humans.

15. A method as described in claim 12, in which said digital elements of the first type are the elements of predefined series associated with distinct identities.

16. A method as described in claim 2, in which digital elements of a second type are generated by at least some of said active permits, are used in performing the cryptographic actions of these particular active permits, and are required to be different at different times in order to cryptographically authenticate said results of these particular active permits, preventing in this way the authentication of forgery attempts by recording and replaying of said results.

17. A method as described in claim 1, in which said control points are moreover planned to acquire a credential from the active permit of each said designated human, said validation key being securely extracted from each acquired credential by performing a cryptographic extraction algorithm involving an extraction key.

18. A method as described in claim 2, in which said validation key is selected from a list of validation keys, according to said determined distinct identity.

19. A method as described in claim 1, in which the cryptographic process consisting of said cryptographic actions in said active permits and said cryptographic authentications of said acquired results, is of a symmetric type, an asymmetric type, or a combination of both.

20. A method as described in claim 1, in which at least some of said control points are further planned to associate each said acquired result to a particular designated human.

21. A method as described in claim 1, in which the memory contents of said active permits can be altered as a consequence of instructions and/or data transmitted from the control points.

22. A method as described in claim 1 in which said required change in the motion conditions of the humans is in the range of 0.5×V-1.5×V, V being the average velocity of the humans before reaching the specific section (21) in the vicinity of said control points.

23. A security system for the detection and/or control of unauthorized humans (10a, 10b, . . . ) among a large number of authorized humans (12a, 12b, . . . ) within a controlled restricted zone (2), to implement the method of claim 1, comprising:
human communication units (50a, 50b, . . . ), borne by all authorized humans, comprising means (52) of activating the transmission of an identification message by the human communication unit, an active permit (60) containing a distinct identity (62), and a transmitter (54),
means of issuing (170), and of revoking (178) of active permits (60a, 60b, . . . ),
at least one database (180) containing authorization data regarding humans,
automatic control points (20a, 20b, . . . ), and optionally manual control points (40a, 40b, . . . ), both distributed in the controlled restricted zone (2), each automatic control point comprising means (22) of detection and counting of all humans entering or moving through a specific section (21) in its vicinity, and each manual control point comprising means of selection (42) of humans by the action of an operator, the humans detected by the automatic control points and the humans selected by the manual control points being hereafter referred to as designated humans, both types of control points additionally comprising means (24) of activating requests for identification to the human communication units of the designated humans, means (26) of reception capable of receiving identification messages transmitted by human communication units, hereafter referred to as human communication unit responses (90a, 90b, . . . ), and a controller (28) capable of associating human communication unit responses to designated humans,
means (130) of retrieving prior data from the database (180),
means (140) of classification of designated humans,
at least one security center (160),
additional means (44) in the manual control points of notifying the manual control point operator,
a communication network (100) between at least some of the control points, the database (180), the means of issuing (170) and revoking (178) of active permits, the means of retrieving prior data (130), the means of classification (140) and the security centers,
characterized in that:
I) The active permit (60) contains in addition a secret cryptographic key (64) associated to the distinct identity (62) of the active permit (60), and is planned to perform a cryptographic confirmation algorithm (66) involving at least the distinct identity (62) and the secret cryptographic key (64),
II) The human communication unit response (90) comprises the result of the cryptographic confirmation algorithm (66),
III) Means (70) of cryptographic authentication are planned to check for each human communication unit response (90) whether or not the secret cryptographic key (64) corresponding to the distinct identity (62) contained in the human communication unit response (90) was the one used in the calculation of this response (90), this action involving a validation key (74) corresponding to the same distinct identity (62), and a cryptographic validation algorithm (76),
IV) For every newly authorized human, the means (170) of issuing allocate a distinct identity (62), initialize a new active permit (60) to bear the allocated distinct identity (62) and a corresponding secret cryptographic key (64), and update the database (180) with information regarding the newly authorized human (12),
V) The means (178) of revoking are planned to automatically (for example time dependent expiration) and/or manually modify elements in the database (180),
VI) The means of retrieving prior data (130) utilize the distinct identity (62) contained in the human communication unit response (90), in order to retrieve from the database (180), authorization data regarding this human,
VII) The means (140) of classification utilize the data produced by the means (22) of detection and counting, and/or the means (26) of reception, and/or the controller (28), and/or the means (70) of authentication, and/or the means (130) of retrieving prior data, to determine whether a designated human is authorized or not,
VIII) Means (150) of alert convey to at least one security center (160) and/or to the means (44) of notifying the manual control point operator, an alert message containing the data provided by the means (26) of reception, and/or the controller (28), and/or the means (70) of authentication, and/or the means (130) of retrieving prior data, for at least some of the humans classified as unauthorized,
IX) At least some of the control points comprise in addition means (30) of acquiring physical characteristics of designated humans, such as photographic information, height, weight, features, etc . . . , the means of alert (150) additionally include said acquired physical characteristics in at least some of the alert messages.

24. A system according to claim 23, in which the means (70) of authentication are additionally planned to determine the validation key (74), by utilizing the distinct identity (62) contained in the human communication unit response (90), to select from-a validation key list (80) containing for each distinct identity (62) a corresponding validation key (74), and the means (170) of issuing are also additionally planned to update for every newly authorized human (12) the validation key list (80) with the allocated distinct identity (62) and the corresponding validation key (74).

25. A system according to claim 23, in which the human communication unit response (90) additionally comprises a credential (174), the means (70) of authentication being additionally planned to determine the validation key (74), by utilizing a cryptographic extraction algorithm (86) involving an extraction key (78), in order to securely extract the validation key (74) from the credential (174) contained in the human communication unit response (90), and the means (170) of issuing being also additionally planned to initialize for every newly authorized human (12), the active permit (60) with a credential (174) containing the result of a cryptographic binding algorithm (176) involving the validation key (74) and a binding key (172) which corresponds to the extraction key (78).

26. A system according to claim 23, in which the means (24) of activating requests for identification transmit to every designated human an interrogation message.

27. A system according to claim 23, in which the means (24) of activating requests for identification comprise a trigger element in the vicinity of the control point, that is planned to be detectable by means (52) in the human communication units.

28. A system as described in claim 23, which is utilized to perform additional functions such as Admittance Fee Collection, Access Control, in particular on the perimeter of the controlled restricted zone and/or any of its sub-zones, Messaging, Crew Management, statistical survey, a crime investigation tool, etc.

29. A system as described in claim 23, in which the human communication unit (50) is powered by an internal power source (58), and/or by a coil (59) converting the energy of an RF wave generated by means (38) in the control points.
